(19) United States
(12) Patent Application Publication
(10) Pub. No.: US 2012/0002864 A1
(43) Pub. Date: Jan. 5, 2012

(54) IMAGE PROCESSING UNIT, IMAGE PROCESSING METHOD, AND COMPUTER PROGRAM

(75) Inventor: MASAKAZU KOUNO, Tokyo (JP)

(73) Assignee: Sony Corporation, Tokyo (JP)

(21) Appl. No.: 13/161,620

(22) Filed: Jun. 16, 2011

(30) Foreign Application Priority Data
Jul. 2, 2010 (JP) 2010-152366

(51) Int. Cl. G06K 9/00

(52) U.S. Cl. 382/154

(57) ABSTRACT

An image processing unit includes a statistical information calculating section which calculates statistical information in macroblock units with regard to image data with a plurality of fields, a region determination section which executes region determination with regard to the image data with the level of recognition of three-dimensional images as a determination standard using the statistical information calculated by the statistical information calculating section, and an encoding processing section which encodes the image data of each field and generates an encoded stream while changing the content of the encoding process for each of the macroblocks according to the result of the region determination executed by the region determination section.

### BACKGROUND

The present disclosure relates to an image processing unit, an image processing method, and a computer program.

There is a device which complies with a method (for example, MPEG (Moving Picture Experts Group)) where image information is handled digitally, and at that time, is compressed by orthogonal transformation and motion compensation such as a discrete cosine transformation using redundancy which is characteristic to image information with an aim of efficient information transmission and accumulation. In recent years, the device is becoming widely used in both information transmission such as broadcasting and in information reception in normal households.

Furthermore, in recent years, standardization of the standard of AVC (Advanced Video Coding) (MPEG 4 part 10, ISO/IEC 14496-10|ITU-T (International Telecommunication Union-Telecommunication Standardization Sector) H.264) (referred to below as AVC/H.264) is being performed. Between the ITU-T and the ISO/IEC, a group called the JVT (Joint Video Team) has been set up which collectively performs standardization of video encoding, and the standardization is progressing through the group. It is known that, compared to the encoding method of MPEG2 and MPEG4 in the related art, H.264 realizes a higher encoding efficiency but a greater amount of calculation is necessary due to encoding and decryption.

Compared to the existing video encoding method of MPEG2 and MPEG4, AVC/H.264 realizes a compression efficiency (encoding efficiency) which is double or more, but due to this, the processing amount in the decryption process also dramatically increases. In addition, along with the increase in the amount of image data due to increasing the picture quality of the images, the processing amount of the decryption process further increases. However, for example, in a case where a bit stream of transmitted encoded data is sequentially decrypted or a case where encoded data which is recorded in a recording medium is read out, decrypted, and the images are reproduced, there are cases where high-speed and stable performing of the decryption process is demanded where the allowable range of delays due to the decryption process is small.

Therefore, in order to efficiently perform the decryption process, there is a method (for example, Japanese Unexamined Patent Application Publication No. 2000-30047) where speeding-up of the decryption process is realized by dividing up the bit stream of the encoded data into a plurality of units and performing the decryption process in parallel using a plurality of decoders (processors or LSI (Large Scale Integration)).

In the method described in Japanese Unexamined Patent Application Publication No. 2000-30047, the bit stream is distributed to each processor in data units referred to as macroblocks, and the encoding process and the decryption process are performed in parallel. According to this, the speeding-up of the decryption process is realized.

In addition, other than this, for example, there is a method where the bit stream is distributed in data units referred to as slices formed from a plurality of macroblocks as shown in FIG. 1 and the decryption process is executed in parallel. In the case of the example of FIG. 1, the bit stream of one picture is divided into six slices (slice 1 to slice 6) and the slices are distributed two at a time to three processors (processor 1 to processor 3). Each of the processors performs decryption of the slices which are allocated in synchronization in parallel. According to this, the speeding-up of the decryption process is realized.

In contrast, the sale of televisions for households, which are for displaying stereoscopic (3D) content for a user to perceive images with three-dimensional depth, also has begun in earnest, and accompanying this, the desire to create a lot of 3D content is increasing. Accordingly, there is demand for a high-speed encoder for creating a large amount of 3D content in a short time.

### SUMMARY

When an encoder in the related art is normally applied as it is to the encoding of 3D content, encoding is executed with regard to both a left eye image and a right eye image. Then, the encoding is repeated in macroblock units or in picture units. Due to this method, encoding with all image quality maintained as 3D is possible. However, since the amount of data which is to be simply encoded in the 3D content has doubled, there is a problem in that the amount of calculation is at least double or more that at a time of normal content and encoding will take an extremely long time in the encoding method as it is in the related art.

Therefore, it is desirable that an image processing unit, an image processing method, and a computer program are provided which are new and improved and which are able to execute a high-speed encoding process by abbreviating the encoding process in a region other than that where it is easy for a user who is viewing 3D content to perceive 3D images.

According to an embodiment of the disclosure, an image processing unit is provided which has a statistical information calculating section which calculates statistical information in macroblock units with regard to image data with a plurality of fields, a region determination section which executes region determination with regard to the image data with the level of recognition of three-dimensional images as a determination standard using the statistical information calculated by the statistical information calculating section, and an encoding processing section which encodes the image data of each field and generates an encoded stream while changing the content of the encoding process for each of the macroblocks according to the result of the region determination executed by the region determination section.

It is desirable that the region determination section separates the image data into a region which is able to be recognized as three-dimensional images and a region with few differences between fields using the statistical information calculated by the statistical information calculating section and the encoding processing section performs encoding using a process where the region with few differences between fields is simplified more than the image data of another field.

It is desirable that the encoding processing section performs encoding using a fixed movement vector and mode with regard to the region with few differences between fields.

It is desirable that the region determination section separates the region which is able to be recognized as three-dimensional images into a region where it is easy to recognize three-dimensional images and a region where it is difficult to recognize three-dimensional images using the statistical information calculated by the statistical information calculating section and the encoding processing section performs encoding using a process where the region where it is difficult to recognize three-dimensional images is simplified more than the image data from another field.

It is desirable that the encoding processing section performs encoding using a fixed mode with regard to the region with few differences between fields.

It is desirable that the statistical information calculating section calculates luminance and contrast in the macroblock units as statistical information and executes edge determination of the macroblocks.

It is desirable that, in a case where the region determination section determines that regions of a predetermined number or more which are the same region are continuous, information, which shows that the regions of the predetermined number or more are continuous, is transmitted along with an encoded stream generated using the encoding processing section.

In addition, according to another embodiment of the disclosure, an image processing method is provided which includes calculating statistical information in macroblock units with regard to image data with a plurality of fields, executing region determination with regard to the image data with the level of recognition of three-dimensional images as a determination standard using the statistical information calculated by the statistical information calculating section, and encoding the image data of each field and generating an encoded stream while changing the content of the encoding process for each of the macroblocks according to the result of the region determination executed by the region determination section.

According to the embodiments of the disclosure described above, it is possible to provide an image processing unit, an image processing method, and a computer program which are new and improved and which are able to execute a high-speed encoding process by abbreviating the encoding process in a region other than that where it is easy for a user who is viewing 3D content to perceive 3D images.

### BRIEF DESCRIPTION OF THE DRAWINGS

FIG. 1 is an explanatory diagram illustrating the concept of an encoding process of the related art;

FIG. 2 is an explanatory diagram illustrating a configuration of an image processing unit according to an embodiment of the disclosure;

FIG. 3 is an explanatory diagram illustrating a state where one image is divided up into a plurality of macroblocks;

FIG. 4 is an explanatory diagram illustrating a configuration of an encoding processing section;

FIG. 5 is a flow diagram illustrating operation of the image processing unit according to an embodiment of the disclosure;

FIG. 6 is a flow diagram illustrating a region determination process using a region determination section; and

FIG. 7 is an explanatory diagram illustrating a hardware configuration example of the image processing unit according to an embodiment of the disclosure.

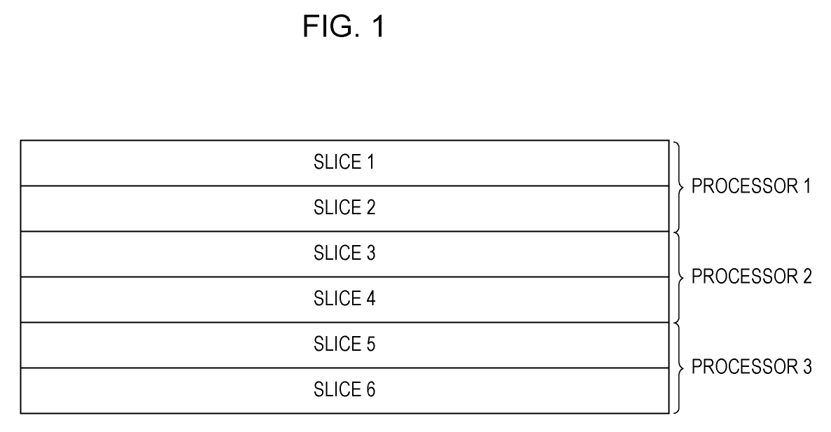

### DETAILED DESCRIPTION OF EMBODIMENTS

Below, an appropriate embodiment of the disclosure will be described in detail while referencing the attached diagrams. Here, in the specifications and the diagrams, overlapping description of constituent elements which practically have the same functional configuration is omitted by attaching the same reference numeral.

Here, the description is performed in the order below.

1. Embodiment of the Disclosure

1-1. Configuration of Image Processing Unit

1-2. Configuration of Encoding Section

1-3. Operation of Image Processing Unit

1-4. Region Determination Process

1-5. Hardware Configuration Example

2. Summary

### 1. Embodiment of the Disclosure

1-1. Configuration of Image Processing Unit

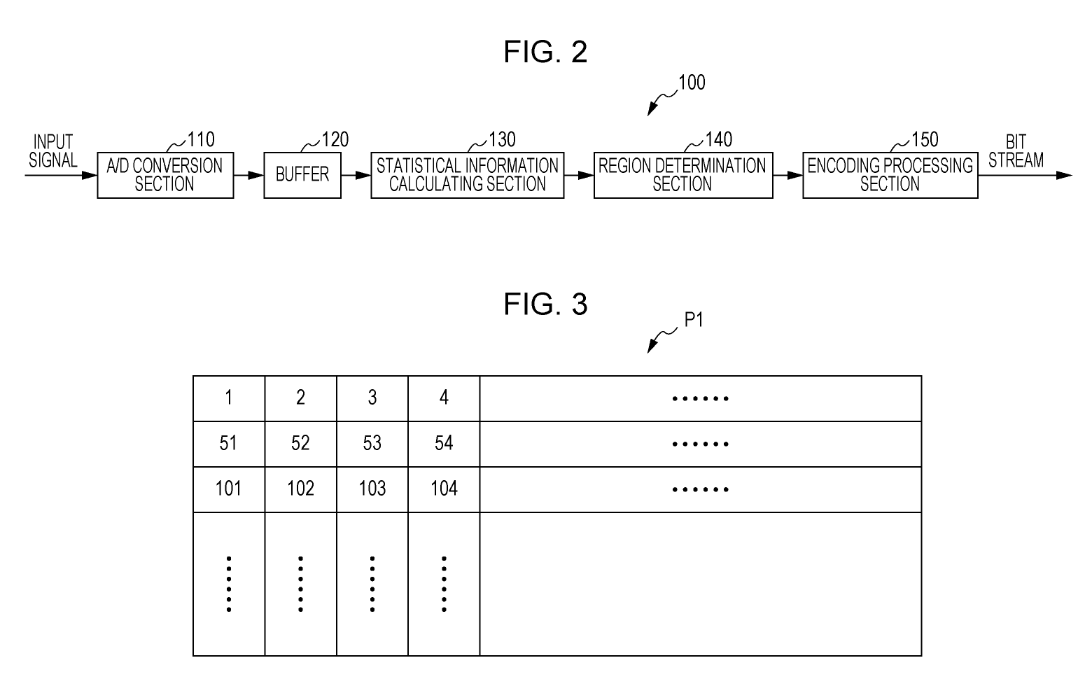

First, a configuration of an image processing unit according to an embodiment of the disclosure will be described while referencing the diagrams. FIG. 2 is an explanatory diagram illustrating a configuration of an image processing unit 100 according to an embodiment of the disclosure. Below, using FIG. 2, the configuration of the image processing unit 100 according to the embodiment of the disclosure will be described.

In the image processing unit 100 according to the embodiment, not just normal images (2D images) but also 3D images are sent. In a case where the image processing unit 100 sends 3D images, an encoding process is executed with regard to both a left eye image and a right eye image. As shown in FIG. 2, the image processing unit 100 according to the embodiment of the disclosure is configured to include an A/D conversion section 110, a buffer 120, a statistical information calculating section 130, a region determination section 140, and an encoding processing section 150.

The A/D conversion section 110 converts an analog image signal (input signal), which is supplied from outside of the image processing unit 100, into digital data. After converting the image signal to digital image data, the A/D conversion section 110 outputs the digital image data to the buffer 120 at a later stage. Here, in a case where the image signal, which is supplied from outside of the image processing unit 100, is digital data, it is not necessary to go through the A/D conversion section 110.

The buffer 120 receives supply of the digital image data output from the A/D conversion section 110 and performs rearranging of frames according to the GOP (Group of Pictures) structure of image compression information. The image data where rearranging of the frames has been performed in the buffer 120 is sent to the statistical information calculating section 130.

The statistical information calculating section 130 reads out each of the left eye image and the right eye image in picture units with regard to the image data where rearranging of the frames has been performed in the buffer 120 and calculates statistical information of each of the frames in macroblock units of each of the left eye image and the right eye image.

FIG. 3 is an explanatory diagram illustrating a state where one image is divided up into a plurality of macroblocks. A picture P1 shown in FIG. 3 shows the image data of one picture and each of the box blocks inside thereof show the respective macroblocks. Here, the number in the respective macroblocks indicates an example of respective distinguishing information (macroblock addresses) in a modeled manner. The macroblock addresses are allocated in a raster order from the macroblock on the upper left edge with natural numbers in an ascending order.

The statistical information calculating section 130 reads out each of the left eye image and the right eye image in picture units and calculates an average luminance value, a dispersion value, and contrast in macroblock units for each of the left eye image and the right eye image as the statistical information as well as executing a determination of whether or not the macroblock is an edge portion. The respective information is, for example, calculated as below.

It is possible to calculate an average luminance value Avg by calculating all image values Xᵢ in pixel units and dividing by the total number of pixels in the macroblock. In addition, it is possible to calculate the dispersion value using Var²=(Xᵢ−Avg)². Furthermore, it is possible to calculate a contrast value Contrast using Contrast=(Σ Xᵢ−Avg)/256.

In addition, in order to distinguish between complex texture and edges which are not able to be determined using only the dispersion value, the statistical information calculating section 130 performs, for example, edge determination as below. Of course, the method shown below is one example of an edge determination method and it is needless to say that the edge determination method in the disclosure is not limited to this example.

(1) Precise Edge Detection

The statistical information calculating section 130 determines an average value of the macroblock units after filtering calculated using a filtering process. That is, the statistical information calculating section 130 calculates Filter_MAD=(Σ|Filter_Xi−Filter_Mean|)/n.

(2) Determination of Ordering of Edge Direction

The statistical information calculating section 130 calculates a Coh value using equation 1 below.

$$Coh = \frac{\sqrt{{( {G}_{xx} - {G}_{yy} )}^{2} + 4 {G}_{xy}^{2}}}{{G}_{xx} + {G}_{yy}} \\ {G}_{xx} = {\sum }_{W} {G}_{x}^{2} , \\ {G}_{yy} = {\sum }_{W} {G}_{y}^{2} , \\ {G}_{xy} = {\sum }_{W} {G}_{τ} {G}_{y} \qquad Equation 1$$

Here, Gx and Gy show responses to the x operator and the y operator of a simple filter. In addition, W indicates Window and this is one macroblock in the embodiment.

The region determination section 140 at a later stage determines that a macroblock is an edge in a case where the value of the Filter_MAD−Filter_Mean determined using (1) above is a higher value than a predetermined value, the Coh value determined using (2) above is a higher value than a predetermined value, and further, the Filter_Mean shows an extremely high response when comparing the Filter_Mean with nearby macroblocks (for example, 8 macroblocks) and the macroblocks which show a low response nearby are half or more.

A sum of absolute differences (SAD) of the left eye image and the right eye image is determined in the manner below. That is, it is possible to determine the sum of absolute differences of the left eye image and the right eye image by calculating the subtraction of image values of the right eye image in pixel units from image values of the left eye image in pixel units for the entire image.

SAD=Σ(Left_{—}Xi−Right_{—}Xi)

In the region determination section 140 at a later stage, whether or not there is a block with a difference between the left eye image and the right eye image is determined using the sum of absolute differences of the left eye image and the right eye image in macroblock units which is calculated first by the statistical information calculating section 130. If there is a block where there is hardly any difference between the left eye image and the right eye image, the normal encoding process (movement prediction and mode determination) is executed on the left eye image and the encoding process using the determined movement vector, frame index, and mode is executed on the right eye image without performing movement prediction and mode determination. Below, the block where there is hardly any difference between the left eye image and the right eye image is referred to as a “region C”.

If there is a block where the sum of absolute differences between the left eye image and the right eye image is a difference equal to more than a predetermined value, since the macroblock is a block where there is a difference between the left eye image and the right eye image, in order to determine whether or not there is a block where it is easy to perceive the macroblock as 3D images, the region determination section 140 performs region determination using the statistical information calculated by the statistical information calculating section 130. Below, a block where it is easy to perceive 3D images is referred to as a “region A” and a block where it is difficult to perceive 3D images is referred to as a “region B”.

The region determination section 140 performs region determination of each of the macroblocks based on the statistical information calculated by the statistical information calculating section 130.

Specifically, as described above, the region determination section 140 determines whether or not there is a block with a difference between the left eye image and the right eye image using the sum of absolute differences of the left eye image and the right eye image in macroblock units which is calculated first by the statistical information calculating section 130. In more detail, the region determination section 140 determines whether or not the sum of absolute differences of the left eye image and the right eye image, which is calculated by the statistical information calculating section 130, exceeds a predetermined threshold.

Next, the region determination section 140 determines whether or not the macroblock, where the sum of absolute differences of the left eye image and the right eye image which is calculated by the statistical information calculating section 130 exceeds the predetermined threshold, is a block where it is easy to perceive 3D images, using the statistical information calculated by the statistical information calculating section 130. If there is a block where it is easy to perceive 3D images, the encoding processing section 150 at a later stage executes the normal encoding process (movement prediction and mode determination) on both of the left eye image and the right eye image of the macroblock. If there is a block where it is difficult to perceive 3D images, the encoding processing section 150 executes the normal encoding process on the left eye image of the macroblock, while, with regard to the right eye image of the macroblock, movement prediction is performed but the encoding process where the mode is fixed to the mode decided in advance is executed by the encoding processing section 150.

In the manner, by the region determination section 140 performing region determination based on the statistical information calculated by the statistical information calculating section 130, in the encoding process by the encoding processing section 150, it is not necessary to execute the normal encoding process (movement prediction and mode determination) on both of the left eye image and the right eye image for all of the macroblocks and it is possible reduce the processing burden when encoding 3D images and reduce the time necessary for the encoding process.

The encoding processing section 150 executes the encoding process with regard to the image data where rearranging of the frames has been performed in the buffer 120.

In the embodiment, the encoding processing section 150 executes the encoding process on the image data using frame interval prediction. Details on the configuration of the encoding processing section 150 will be described later, but in the embodiment, the encoding processing section 150 performs the encoding process on the image data by executing a movement prediction process, a movement compensation process, a mode determination process, a discrete cosine transformation process, a quantization process, and an encoding process.

Then, in the embodiment, the content of the encoding process with regard to the right eye image in the encoding processing section 150 changes based on the determination result by the region determination section 140. With regard to the macroblock (region A) where it is easy to perceive 3D images, the encoding processing section 150 executes the encoding process on the right eye image also in the same manner as the left eye image. On the other hand, with regard to the macroblock (region B) where it is difficult to perceive 3D images, the encoding processing section 150 executes the encoding process with a fixed mode, and with regard to the macroblock (region C) where there no difference between the left eye image and the right eye image, the encoding processing section 150 executes the encoding process using the determined movement vector, frame index, and mode.

In this manner, by changing the content of the encoding process of the encoding processing section 150 according to the region determined by the region determination section 140 based on the statistical information calculated by the statistical information calculating section 130, it is possible reduce the processing burden when encoding 3D images and reduce the time necessary for the encoding process.

Above, the configuration of the image processing unit 100 according to the embodiment of the disclosure has been described using FIG. 2. Next, the configuration of the encoding processing section 150 included in the image processing unit 100 according to the embodiment of the disclosure will be described.

1-2. Configuration of Encoding Section

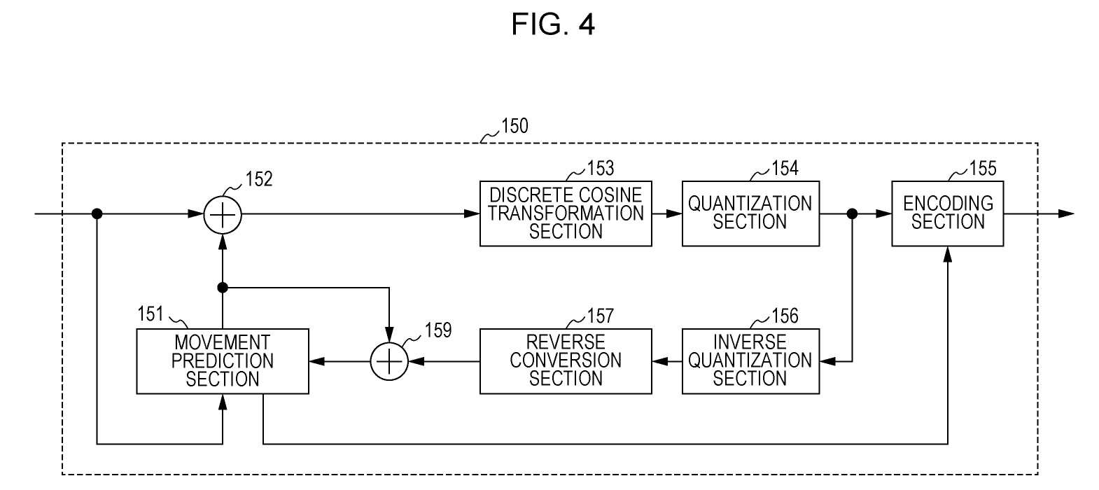

FIG. 4 is an explanatory diagram illustrating the configuration of the encoding processing section 150 included in the image processing unit 100 according to the embodiment of the disclosure. Below, using FIG. 4, the configuration of the encoding processing section 150 included in the image processing unit 100 according to the embodiment of the disclosure will be described.

As shown in FIG. 4, the encoding processing section 150 included in the image processing unit 100 according to the embodiment of the disclosure is configured to include a movement prediction section 151, a discrete cosine transformation section 153, a quantization section 154, an encoding section 155, an inverse quantization section 156, a reverse conversion section 157, and accumulators 152 and 159.

The movement prediction section 151 detects a movement vector of an encoding target image with regard to a reference image and generates a prediction image for each macroblock in accordance with the movement vector by movement compensation with the reference image. The movement prediction section 151 supplies the image data of the prediction image (prediction image data) to the accumulator 152. Here, the encoding target image is an image using the image data sent from the region determination section 140 and the reference image is an image using image data sent from the accumulator 159 described later. When encoding using frame interval prediction (inter-encoding), a difference (prediction residual) of the encoding target image and the prediction image generated by the movement prediction section 151 is determined for each macroblock, and quantization and encoding are performed after an orthogonal transformation of difference data for each of the generated macroblocks.

In addition, the movement prediction section 151 supplies movement vector information which is information relating to the movement vector of the prediction image to the encoding section 155. The encoding section 155 carries out a reversible encoding process with regard to the movement vector information and inserts a header portion of the encoded data generated from the difference data.

Then, the movement prediction section 151 determines the encoding mode of the image data. In the encoding modes of the image data, for example, there is a 16×16 mode where 16 pixels vertically and 16 pixels horizontally are one block, a 8×16 mode where 8 pixels vertically and 16 pixels horizontally are one block, a 16×8 mode where 16 pixels vertically and 8 pixels horizontally are one block, a 8×8 mode where 8 pixels vertically and 8 pixels horizontally are one block, and the like. More specifically, the movement prediction section 151 detects the optimal mode when inter-encoding by movement compensation with the reference image using the detected movement vector. In addition, in a case where the encoding process is executed using inter-encoding, the movement prediction section 151 generates the prediction image data using the optimal mode and supplies the prediction image data to the accumulator 152.

The accumulator 152 determines and outputs the difference (prediction residual) of the image data supplied by the encoding processing section 150 and the prediction image generated by the movement prediction section 151 for each macroblock. The difference data for each macroblock generated by the accumulator 152 is supplied to the discrete cosine transformation section 153, a discrete cosine transformation is performed, quantization is performed in the quantization section 154, and encoding is performed in the encoding section 155.

The discrete cosine transformation section 153 performs the discrete cosine transformation for each of the macroblocks with regard to the image data supplied from the accumulator 152. Here, in the embodiment, the discrete cosine transformation is performed in the discrete cosine transformation section 153, but an orthogonal transformation such as a Karhunen-Loeve transformation may be carried out in the disclosure. The discrete cosine transformation section 153 supplies the orthogonal transformation coefficient obtained through the discrete cosine transformation to the quantization section 154. Here, the data unit where the orthogonal transformation process is performed (orthogonal transformation process unit) is set as an encoding process unit. That is, in this case, the encoding process unit is the macroblock.

The quantization section 154 performs quantization with regard to the orthogonal transformation coefficient supplied from the discrete cosine transformation section 153. The quantization section 154 supplies the data after quantization to the encoding section 155. In addition, the quantization section 154 also supplies the quantized orthogonal transformation coefficient to the inverse quantization section 156.

The encoding section 155 carries out encoding (reversible encoding) such as variable-length encoding or arithmetic encoding with regard to the orthogonal transformation coefficient quantized by the quantization section 154 and outputs the obtained encoded data. The encoding data is output as a bit stream at a predetermined timing after being temporarily accumulated by an accumulating means such as a buffer (not shown). Here, the accumulating means which accumulates the encoding data outputs information on an encoding amount of the accumulated encoding data, that is, the generated encoding amount of the reversible encoding of the encoding section 155, and the encoding section 155 may perform quantization in accordance with a quantization scale calculated based on the information on the generated encoding amount.

Here, as described above, the encoding section 155 receives supply of the movement vector information, which is information relating to the movement vector of the prediction image, from the movement prediction section 151. The encoding section 155 carries out the reversible encoding process with regard to the movement vector information and inserts the header portion of the encoded data generated from the difference data.

The inverse quantization section 156 inverse quantizes the orthogonal transformation coefficient quantized in the quantization section 154 and the obtained orthogonal transformation coefficient is supplied to the reverse conversion section 157. The reverse conversion section 157 performs a reverse discrete cosine transformation, which corresponds to the discrete cosine transformation process performed in the discrete cosine transformation section 153, with regard to the supplied orthogonal transformation coefficient, and the obtained image data (digital data) is supplied to the accumulator 159. Here, in a case where an orthogonal transformation other than the discrete cosine transformation is performed, the reverse conversion section 157 executes a reverse orthogonal transformation which corresponds to the orthogonal transformation. The accumulator 159 adds the image of the prediction image data (prediction image) supplied by the movement prediction section 151 to the image data output from the reverse conversion section 157 and generates the reference image. The reference image which is generated by the accumulator 159 is read out using the movement prediction section 151 after being temporarily accumulated in a frame memory (not shown).

By the encoding processing section 150 having a configuration such as this, it is possible for the image data to be encoded and output as a bit stream by the image processing unit 100. However, the processing time is simply doubled when the same encoding process is executed with regard to both the left eye image and the right eye image. In particular, the movement prediction process and the mode determination process in the movement prediction section 151 take time.

Here, if there is hardly any difference in the left eye image and the right eye image (that is, if the images are significantly closer to 2D images than 3D images), encoding is performing using determined parameters without executing the movement prediction process and the mode determination process again for the right eye image. In addition, even if there is a certain difference in the left eye image and the right eye image, if there is a region where it is difficult to perceive 3D images, the encoding process is executed with partial omissions in the movement prediction process and the mode determination process in the movement prediction section 151.

In this manner, by changing the process content of the movement prediction section 151 according to the processing target macroblock, it is not necessary to execute the movement prediction process and the mode determination process with regard to all of the images and it is possible to reduce the time necessary for the encoding process of the image data.

Above, the configuration of the encoding processing section 150 included in the image processing unit 100 according to the embodiment of the disclosure has been described using FIG. 4. Next, operation of the image processing unit 100 according to the embodiment of the disclosure will be described.

1-3. Operation of Image Processing Unit

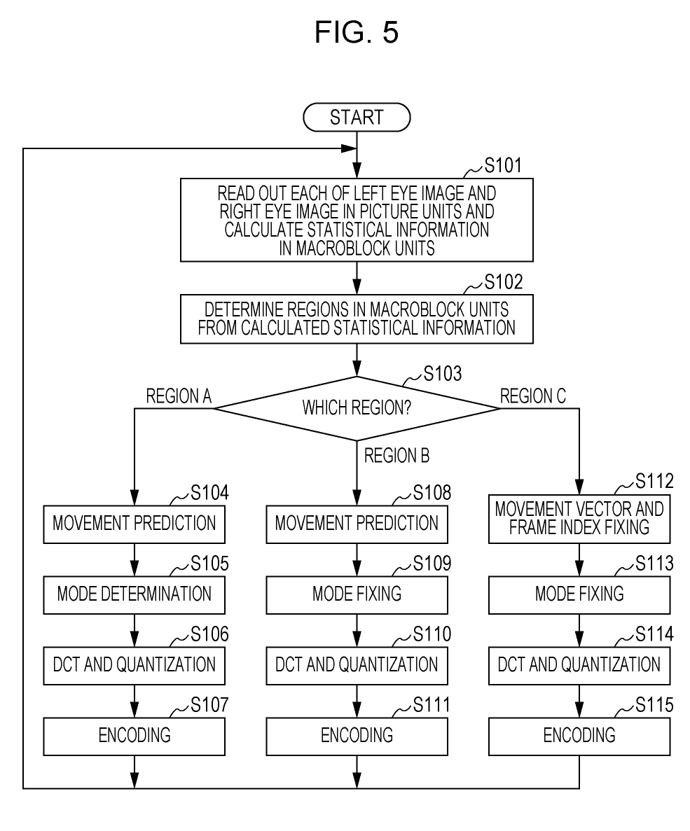

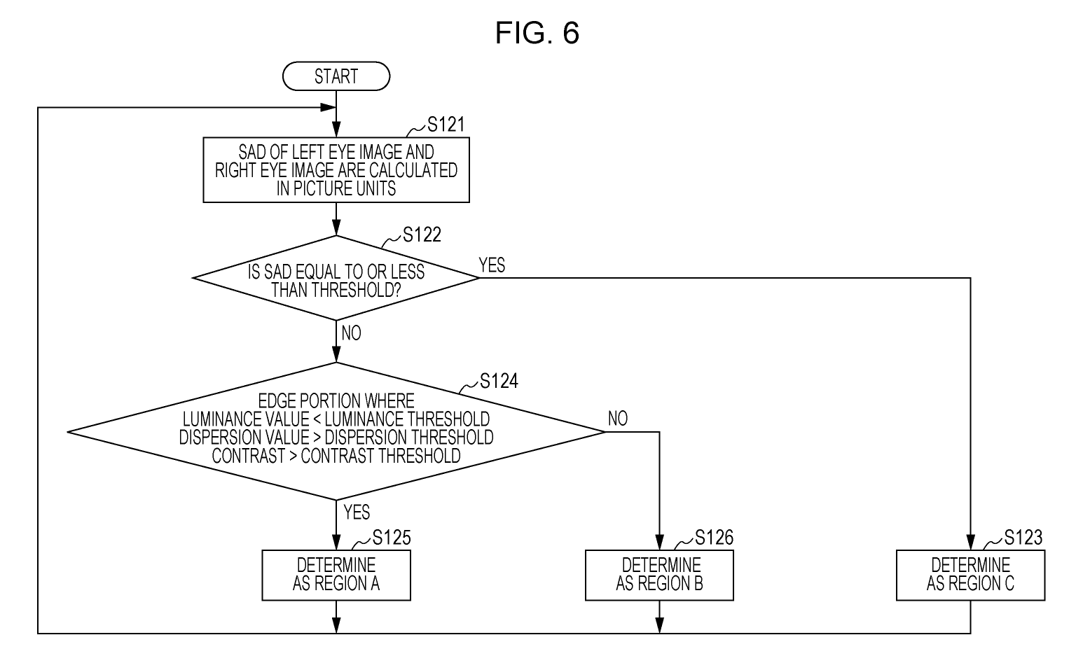

FIG. 5 is a flow diagram illustrating operation of the image processing unit 100 according to the embodiment of the disclosure. Below, using FIG. 5, operation of the image processing unit 100 according to the embodiment of the disclosure will be described.

In the image processing unit 100, when encoding the image data, the statistical information calculating section 130 reads out each of the left eye image and the right eye image in picture units at the same timing and calculates the statistical information in macroblock units (step S101). By the statistical information calculating section 130 calculating the statistical information with regard to each of the left eye image and the right eye image at the same timing, region determination is possible based on the statistical information in macroblock units in the image.

The statistical information which is calculated in macroblock units by the statistical information calculating section 130 in step S101 described above, is the average luminance value, the dispersion value, and the contrast in macroblock units, and the sum of absolute differences of the left eye image and the right eye image. In addition, the statistical information calculating section 130 executes a determination of whether or not the macroblock is an edge portion.

When the statistical information is calculated in macroblock units using the statistical information calculating section 130 in step S101 described above, next, the region determination section 140 determines the regions of each macroblock using the statistical information which is calculated in macroblock units by the statistical information calculating section 130 (step S102). How the region determination section 140 determines the regions of each macroblock using which of the statistical information will be described in detail afterwards, but firstly, whether the macroblock is displayed as a 3D image or whether the macroblock is a 2D image in practice is distinguished from the sum of absolute differences of the left eye image and the right eye image. Then, if the macroblock is displayed as a 3D image, it is further distinguished whether or not the macroblock is a region where it is easy to perceive 3D images using the statistical information which is calculated in macroblock units by the statistical information calculating section 130 in step 5101 described above. By distinguishing the regions in this manner, the encoding process which depends on the region is possible, and it is possible to partially speed-up the encoding process and to improve the encoding efficiency.

In step S102 described above, when the region determination section 140 determines the regions of each macroblock, next, the encoding processing section 150 executes the encoding process with regard to each macroblock. In the encoding processing section 150, the movement prediction section 151 executes the movement prediction process and the encoding mode of the image data is determined. Next, the accumulator 152 determines and outputs the difference (prediction residual) of the image data supplied by the encoding processing section 150 and the prediction image generated by the movement prediction section 151 for each macroblock. Then, the discrete cosine transformation section 153 executes the discrete cosine transformation process and the quantization section 154 performs quantization with regard to the orthogonal transformation coefficient supplied from the discrete cosine transformation section 153. Lastly, the encoding section 155 carries out encoding (reversible encoding) such as variable-length encoding or arithmetical encoding with regard to the orthogonal transformation coefficient quantized by the quantization section 154 and outputs the obtained encoded data.

Then, in the embodiment, when the encoding process with regard to the right eye image is executed according to the region of each macroblock determined by the region determination section 140 in step 5102 described above, the movement prediction section 151 changes the processing content. According to this, in the image processing unit 100 according to the embodiment, the encoding process which depends on the region is possible, and it is possible to partially speed-up the encoding process and to improve the encoding efficiency. Here, in the process described below, it is assumed that the series of the encoding processes of the left eye image which is the base image has been completed.

The movement prediction section 151 determines which region the macroblock to be process is (step S103).

In a case where the result of the determination in step S103 described above is that the macroblock to be process is the region A, the movement prediction section 151 executes the movement prediction process with regard to the right eye image (step S104). Then, when the movement prediction process with regard to the right eye image is completed, next, the movement prediction section 151 determines the encoding mode of the macroblock based on the result of the movement prediction process (step S105).

When the movement prediction section 151 executes the movement prediction process and determines the encoding mode of the macroblock, next, the accumulator 152 determines and outputs the difference (prediction residual) of the image data supplied by the encoding processing section 150 and the prediction image generated by the movement prediction section 151 for each macroblock.

Then, the discrete cosine transformation section 153 executes the discrete cosine transformation process and the quantization section 154 performs quantization with regard to the orthogonal transformation coefficient supplied from the discrete cosine transformation section 153 (step S106).

Lastly, the encoding section 155 carries out encoding (reversible encoding) such as variable-length encoding or arithmetical encoding with regard to the orthogonal transformation coefficient quantized by the quantization section 154 and outputs the obtained encoded data (step S107).

Next, in a case where the result of the determination in step S103 described above is that the macroblock to be process is the region B, the movement prediction section 151 executes the movement prediction process with regard to the right eye image (step S108). Then, when the movement prediction process with regard to the right eye image is completed, next, the movement prediction section 151 selects the encoding mode of the macroblock (step S109).

For example, if the macroblock is a smooth portion (a value with an extremely small dispersion value), it is possible for the movement prediction section 151 to select the 16×16 mode where the header bit is the smallest. In addition, if the macroblock is a complex portion (a value with a large dispersion value), it is possible to perform encoding at a higher speed than normal encoding while maintaining a given degree of image quality if it is made so that it is possible to finely perform movement compensation in advance by the movement prediction section 151 selecting the 8×8 mode.

The movement prediction section 151 executes the movement prediction process, and when the encoding mode of the macroblock is determined, next, the accumulator 152 determines and outputs the difference (prediction residual) of the image data supplied by the encoding processing section 150 and the prediction image generated by the movement prediction section 151 for each macroblock.

Then, the discrete cosine transformation section 153 executes the discrete cosine transformation process and the quantization section 154 performs quantization with regard to the orthogonal transformation coefficient supplied from the discrete cosine transformation section 153 (step S110).

Lastly, the encoding section 155 carries out encoding (reversible encoding) such as variable-length encoding or arithmetical encoding with regard to the orthogonal transformation coefficient quantized by the quantization section 154 and outputs the obtained encoded data (step S111).

Then, in a case where the result of the determination in step S103 described above is that the macroblock to be process is the region C, the movement prediction section 151 uses a movement vector and a frame index determined in advance without performing the movement prediction process with regard to the right eye image (step S112). Then, the movement prediction section 151 selects the use of the encoding mode determined in advance with regard to the macroblock (step S113).

The movement prediction section 151 selects the use of the movement vector and the frame index determined in advance, and when the encoding mode of the macroblock is determined, next, the accumulator 152 determines and outputs the difference (prediction residual) of the image data supplied by the encoding processing section 150 and the prediction image generated by the movement prediction section 151 for each macroblock.

Then, the discrete cosine transformation section 153 executes the discrete cosine transformation process and the quantization section 154 performs quantization with regard to the orthogonal transformation coefficient supplied from the discrete cosine transformation section 153 (step S114).

Lastly, the encoding section 155 carries out encoding (reversible encoding) such as variable-length encoding or arithmetical encoding with regard to the orthogonal transformation coefficient quantized by the quantization section 154 and outputs the obtained encoded data (step S115).

Here, the encoding processing section 150 repeatedly executes the processes from step S103 to step S111 in sequence with regard to all of the macroblocks in one image, and when the encoding processes of all of the macroblocks is completed, the process returns to step S101 described above and the calculation of the statistical information in macroblock units is executed by the statistical information calculating section 130.

In this manner, by changing the encoding process of the encoding processing section 150 depending on the macroblocks, it is possible to reduce the time necessary for the encoding process compared to the case where the movement prediction process, the movement compensation process, and the mode determination process are executed with regard to both the left eye image and the right eye image.

Table below summaries the relationship between each of the regions determined by the region determination section 140 and the movement prediction process and the movement determination process. Simplified processes are indicated by the ◯ in Table. In this manner, by changing the simplified processes depending on the region determined by the region determination section 140, it is possible for the image processing unit 100 according to the embodiment of the disclosure to achieve the reduction of the processing time compared to the case where the movement prediction process and the mode determination process are executed with regard to the entire image.

TABLE

| | Region A | Region B | Region C |
|---|---|---|---|
| Movement Prediction | | | ◯ |
| Mode Determination | | ◯ | ◯ |

Above, operation of the image processing unit 100 according to the embodiment of the disclosure has been described using FIG. 5. Next, the region determination process for each macroblock in step S102 described above using the region determination section 140 will be described in detail.

1-4. Region Determination Process

FIG. 6 is a flow diagram illustrating the region determination process using the region determination section 140 included in the image processing unit 100 according to the embodiment of the disclosure. Below, using FIG. 6, the region determination process using the region determination section 140 will be described in detail.

First, before the region determination process using the region determination section 140, the sum of absolute differences (SAD) of the left eye image and the right eye image are calculated in picture units by the statistical information calculating section 130 (step S121). The calculation of the sum of absolute differences of the left eye image and the right eye image is performed to distinguish the block where the encoding process is to be performed where the macroblock set as a 3D image and the block where there are no problems in performing the encoding process where the macroblock set as a 2D image.

When the sum of absolute differences (SAD) of the left eye image and the right eye image are calculated in picture units by the statistical information calculating section 130 in step S121 described above, next, the region determination section 140 determines whether or not the sum of absolute differences of the left eye image and the right eye image calculated by the statistical information calculating section 130 is equal to or less than a predetermined threshold (step S122).

In a case where the result of the determination in step S122 described above is that the sum of absolute differences of the left eye image and the right eye image calculated by the statistical information calculating section 130 is equal to or less than the predetermined threshold, the region determination section 140 determines that the macroblock is the region C (step S123). This is because, if the sum of absolute differences of the left eye image and the right eye image is equal to or less than the predetermined threshold, the macroblock is the block where there are no problems in performing the encoding process where the macroblock is set as a 2D image. Accordingly, in regard to the macroblock where the sum of absolute differences of the left eye image and the right eye image is equal to or less than the predetermined threshold, the encoding processing section 150 executes the encoding process using the movement vector, the frame index, and the encoding mode determined in advance with regard to the right eye as described above.

On the other hand, in a case where the result of the determination in step S122 described above is that the sum of absolute differences of the left eye image and the right eye image calculated by the statistical information calculating section 130 exceeds the predetermined threshold, the macroblock is the block where the encoding process is to be performed by the encoding processing section 150 with the macroblock being set as a 3D image with a certain difference between the left eye image and the right eye image.

However, even in a case where encoding is to be performed where the macroblock is set as a 3D image, by changing the content of the encoding process by the encoding processing section 150 depending on whether or not it is easy to perceive the macroblock as 3D images, it is possible to reduce the time necessary for the encoding process with regard to one image. To distinguish whether or not there is the block where it is easy to perceive 3D images, the region determination section 140 uses the statistical information calculated by the statistical information calculating section 130.

The region where it is easy to perceive 3D images is typically an edge region where parallax is large (a sensation of depth is perceived). Accordingly, the region determination section 140 distinguishes whether the macroblock which is a region determination process target has contrast which is a value equal to or more than a given constant and brightness which is equal to or less than a given constant, where it is typically easy to perceive a sensation of depth, and is the edge region with a high dispersion value (step S124). If simply the macroblocks with a high dispersion value were only detected as the regions where it is easy to perceive 3D images, there is a concern that images which have a complex texture will be included. There are cases where the macroblock which has a complex texture is where the image is too fine and it is difficult to detect as 3D images in terms of visual characteristics.

In a case where the result of the determination in step S124 described above is that the region determination section 140 determines that the macroblock which is the region determination process target has contrast which is a value equal to or more than a given constant and brightness which is equal to or less than a given constant, where it is typically easy to perceive a sensation of depth, and is the edge region with a high dispersion value, the region determination section 140 determines that the macroblock is the region A (step S125). Since the region A is the region where it is easy to perceive 3D images when the images are viewed, the encoding process with regard to the right eye image is not omitted and the encoding process in the same manner as the left eye image is executed.

On the other hand, when the result of the determination in step S124 described above is that the region determination section 140 determines that there is the region which does not satisfy the conditions, the region determination section 140 determines that the macroblock is the region B (step S126). Since the region B is the region where it is difficult to perceive 3D images when the images are viewed compared to the region A, it is not possible to significantly omit the encoding process in the same manner as the region C, but it is possible to reduce the time necessary for the encoding process by simplifying a portion of the process. Specifically, the movement prediction process with regard to the right eye image is executed, but it is possible to reduce the processes compared to the encoding process with regard to the region A by the extent to which the encoding mode determination process is not performed by setting the encoding mode to the mode determined in advance.

Here, the mode may be selected with regard to the region B according to the encoding conditions. For example, an inter 16×16 mode where the header bit is the smallest is selected if the image is a smooth portion (a value with an extremely small dispersion value) and movement prediction is performed, and it is possible to perform encoding at a higher speed than when normal encoding is performed on the right eye image while maintaining a given degree of image quality if it is made so that it is possible to finely perform movement compensation in advance by selecting an inter 8×8 mode if the image is a complex portion (a value with a high dispersion value).

The region determination section 140 repeatedly executes the series of the region determination process in sequence in macroblocks units and in picture units. By the region determination section 140 executing the series of the region determination process in sequence in macroblocks units, it is possible for the encoding processing section 150 to receive the result of the region determination process and for the encoding processing section 150 to change the content of the encoding process in macroblock units. Then, by the encoding processing section 150 changing the content of the encoding process in macroblock units, it is possible to effectively reduce the time necessary for the encoding process.

1-5. Hardware Configuration Example

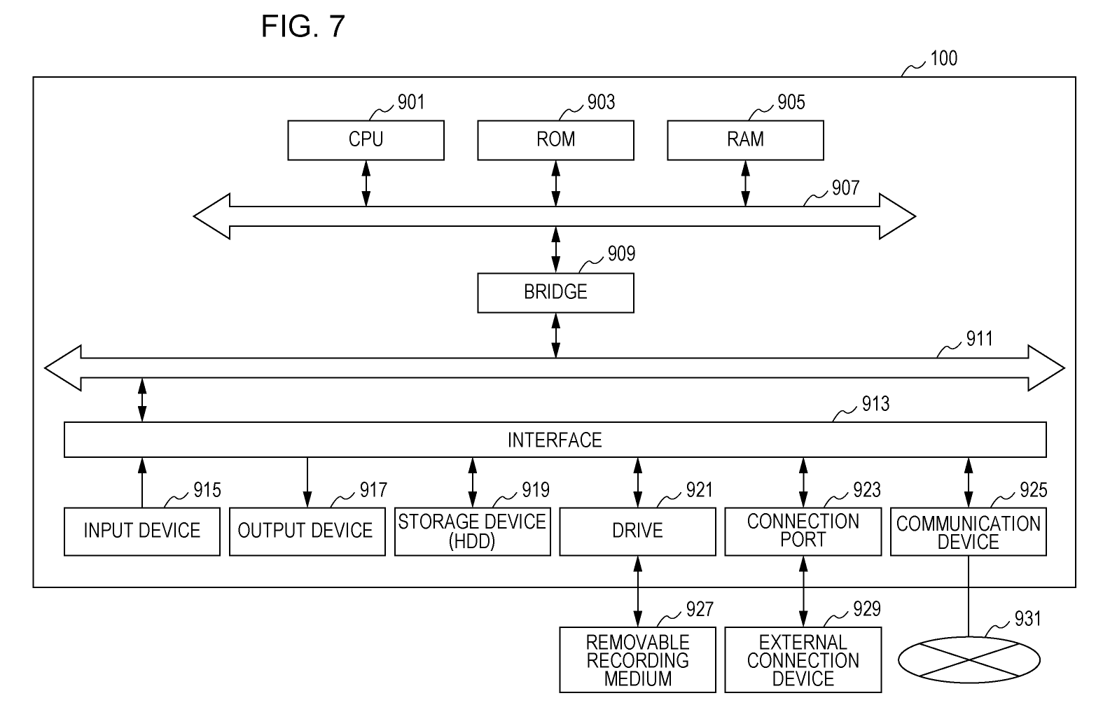

Next, one example of the hardware configuration of the image processing unit 100 described above will be described. FIG. 7 is an explanatory diagram illustrating a hardware configuration example of an image processing unit according to an embodiment of the disclosure.

As shown in FIG. 7, the image processing unit 100 is mainly provided with a CPU 901, a ROM 903, a RAM 905, a host bus 907, a bridge 909, an external bus 911, an interface 913, an input device 915, an output device 917, a storage device 919, a drive 921, a connection port 923, and a communication device 925.

The CPU 901 functions as a calculation processing device and a control device, and controls the overall or part of the operation of the image processing unit 100 in accordance with each type of program stored in the ROM 903, the RAM 905, the storage device 919 and a removable recording medium 927. The ROM 903 stores a program, calculation parameters, and the like used by the CPU 901. The RAM 905 temporarily stores the program used in the execution by the CPU 901, parameters which arbitrarily change in the execution, and the like. The CPU 901, the RAM 903, and the ROM 905 are mutually connected using the host bus 907 configured by an internal bus such as a CPU bus.

The host bus 907 is connected to the external bus 911 such as a PCI (Peripheral Component Interconnect/Interface) bus via the bridge 909.

The input device 915 is, for example, an operating means which is operated by a user such as a mouse, a keyboard, a touch panel, a button, a switch, and a lever. In addition, the input device 915 may be, for example, a remote control means (a so-called remote control) which uses infrared light or other waves or an external connection device 929 such as a mobile phone or a PDA which corresponds to the operation of the image processing unit 100. Furthermore, the input device 915, for example, generates an input signal based on information input by a user using the operating means described above and is configured by an input control circuit or the like which outputs to the CPU 901. It is possible for the user of the image processing unit 100 to input various types of data and instruct a process operation with regard to the image processing unit 100 by operating the input device 915.

The output device 917 is, for example, configured by a device, such as a display device, such as a CRT display device, a liquid crystal display device, a plasma display device, an EL display device, or a lamp, a sound output device, such as a speaker or headphones, a printing device, a mobile phone, or a facsimile, which is able to visually or aurally notify a user of obtained information. The output device 917 outputs, for example, the results obtained due to each type of process performed by the image processing unit 100. Specifically, the display device displays the result obtained due to each type of process performed by the image processing unit 100 as text or an image. On the other hand, the sound output device converts an audio signal formed from reproduced sound data, acoustic data, and the like to an analog signal and outputs the analog signal.

The storage device 919 is, for example, configured by a magnetic storage section device such as a HDD (Hard Disk Drive), a semiconductor storage device, an optical storage device, a magneto-optical storage device, or the like. The storage device 919 stores a program which is executed by the CPU 901, various types of data, acoustic signal data and image signal data which is obtained from the outside, and the like.

The drive 921 is a reader/writer for recording media and is built into the image processing unit 100 or is attached externally. The drive 921 reads out information recorded on the removable recording medium 927 such as a magnetic disc, an optical disc, a magneto-optical disc, or a semiconductor memory which is mounted therein and outputs the information to the RAM 905. In addition, the drive 921 is able to write a recording into the removable recording medium 927 such as a magnetic disc, an optical disc, a magneto-optical disc, or a semiconductor memory which is mounted therein. The removable recording medium 927 is, for example, a DVD medium, a Blu-ray medium, a compact flash (CF) (registered trademark), a memory stick, a SD memory card (Secure Digital memory card), or the like. In addition, the removable recording medium 927 may be an IC card (Integrated Circuit card) which is mounted with a non-contact-type IC chip, a digital device, or the like.

The connection port 923 is, for example, a port for directly connecting a USB (Universal Serial Bus) port, an IEEE 1394 port such as an i.Link, a SCSI (Small Computer System Interface) port, a RS-232C port, an optical audio terminal, an HDMI (High-Definition Multimedia Interface) port, or the like, to the image processing unit 100. By connecting the connection port 923 to the external connection device 929, the image processing unit 100 obtains direct acoustic signal data and image signal data from the external connection device 929 and provides acoustic signal data and image signal data to the external connection device 929.

The communication device 925 is, for example, a communication interface which is configured by a communication device or the like for connection to a communication network 931. The communication device 925 is, for example, a communication card for a wired or wireless LAN (Local Area Network), Bluetooth, or WUSB (Wireless USB), a router for optical communication, a route for ADSL (Asymmetric Digital Subscriber Line), a modem for each type of communication, or the like. It is possible for the communication device 925 to send and receive signals and the like, for example, in accordance with a predetermined protocol such as TCP/IP between, for example, the internet and another communication device. In addition, the communication network 931 to which the communication device 925 is connected is configured by a network or the like which is connected by wires or wirelessly, and for example, may be the internet, a household LAN, infrared communication, radio wave communication, satellite communication, or the like.

### 2. Summary

According to the embodiment of the disclosure described above, when an image which is to be displayed as a 3D image is divided into macroblocks and encoded, the region determination process is executed with regard to the macroblocks and it is possible to effectively reduce the time necessary for the encoding process by changing the encoding process depending on the region.

Specifically, with regard to each of the macroblocks, first, it is determined whether or not the sum of absolute differences of the left eye image and the right eye image is equal to or less than the predetermined value, and if the sum of absolute differences of the left eye image and the right eye image exceeds the predetermined threshold, next, it is determined whether or not there is the region where it is easy to perceive 3D images when the images are viewed. By determined each of the macroblocks and setting the regions in this manner, the encoding process which depends on the region is possible and it is possible to effectively reduce the time necessary for the encoding process.

Here, the dividing up of the regions using the region determination section 140 described above does not only speed-up the encoding but also is able to be used in the allocation of encoding amounts. Accordingly, by allocating, for example, more of the encoding amount to the regions A, it is possible to also achieve higher image quality in the encoding process by the encoding section 155.

In addition, in the specifications, the steps which are written into the program recorded in the recording medium includes, of course, the process which is performed in a time series manner along the described order and also the process which is executed in a parallel manner or independently without being necessarily processed in a time series manner.

Above, an appropriate embodiment of the disclosure is described in detail while referencing the attached diagrams, but the disclosure is not limited to this example. It should be understood by those skilled in the art of the technical field to which the disclosure belongs that various modifications and alterations are possible within the scope of the technical concept described in the range of the claims and that these modifications and alterations belong to the technical scope of the disclosure.

For example, in a case where the result of the region determination using the region determination section 140 is that a predetermined number or more of the same region is continuous in a row, a graph which shows this may be attached when encoding. For example, in a case where the result of the region determination using the region determination section 140 is that a predetermined number (for example, ten) of the region B is continuous in a row, a graph which shows this is attached at a time of the encoding process of the encoding processing section 150. According to this, when performing decryption on a certain location, it is possible to effectively perform decryption using not only units of single macroblocks but also units of a predetermined number of macroblocks which are continuous.

The form of the disclosure has been described as the information which is shown as continuous being multiplexed (inserted or written) with a bit stream, but other than multiplexing, information and images (or bit stream) may be transmitted (recorded). Furthermore, the transmission in the disclosure has a meaning of the stream and the information being linked and recorded in a transmission or recording medium.

Here, in the form of the disclosure, the linking is defined as below. The linking may be a state where images (or bit stream) and information are linked to each other. For example, images (or bit stream) and formation determination information may be transmitted using different transmission paths. In addition, images (or bit stream) and information may be recorded on recording media which are different from each other (or in recording areas which are independent in the same recording medium). Here, the unit where images (or bit stream) and information are linked may be, for example, set as the encoding process unit (one frame, a plurality of frames, or the like).

The present disclosure contains subject matter related to that disclosed in Japanese Priority Patent Application JP 2010-152366 filed in the Japan Patent Office on Jul. 2, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing unit comprising:
a statistical information calculating section which calculates statistical information in macroblock units with regard to image data with a plurality of fields;
a region determination section which executes region determination with regard to the image data with the level of recognition of three-dimensional images as a determination standard using the statistical information calculated by the statistical information calculating section; and
an encoding processing section which encodes the image data of each field and generates an encoded stream while changing the content of the encoding process for each of the macroblocks according to the result of the region determination executed by the region determination section.

2. The image processing unit according to claim 1,
wherein the region determination section separates the image data into a region which is able to be recognized as three-dimensional images and a region with few differences between fields using the statistical information calculated by the statistical information calculating section, and
the encoding processing section performs encoding using a process where the region with few differences between fields is simplified more than the image data of another field.

3. The image processing unit according to claim 2,
wherein the encoding processing section performs encoding using a fixed movement vector and mode with regard to the region with few differences between fields.

4. The image processing unit according to claim 2,
wherein the region determination section separates the region which is able to be recognized as three-dimensional images into a region where it is easy to recognize three-dimensional images and a region where it is difficult to recognize three-dimensional images using the statistical information calculated by the statistical information calculating section, and
the encoding processing section performs encoding using a process where the region where it is difficult to recognize three-dimensional images is simplified more than the image data from another field.

5. The image processing unit according to claim 4,
wherein the encoding processing section performs encoding using a fixed mode with regard to the region with few differences between fields.

6. The image processing unit according to claim 1,
wherein the statistical information calculating section calculates luminance and contrast in the macroblock units as statistical information and executes edge determination of the macroblocks.

7. The image processing unit according to claim 1,
wherein, in a case where the region determination section determines that regions of a predetermined number or more which are the same region are continuous, information, which shows that the regions of the predetermined number or more are continuous, is transmitted along with an encoded stream generated using the encoding processing section.

8. An image processing method comprising:
calculating statistical information in macroblock units with regard to image data with a plurality of fields;
executing region determination with regard to the image data with the level of recognition of three-dimensional images as a determination standard using the statistical information calculated by the statistical information calculating section; and
encoding the image data of each field and generating an encoded stream while changing the content of the encoding process for each of the macroblocks according to the result of the region determination executed by the region determination section.
